(19) United States
(12) Patent Application Publication
(10) Pub. No.: US 2005/0289245 A1
(43) Pub. Date: Dec. 29, 2005

(54) Restricting virus access to a network

(76) Inventors: Jonathan Griffin, Bristol (GB); Andrew Patrick Norman, Bristol (GB); Matthew Murray Williamson, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/144,461

(22) Filed: Jun. 3, 2005

(30) Foreign Application Priority Data
Jun. 23, 2004 (GB) GB0414060.4

(51) Int. Cl. G06F 15/16

(52) U.S. Cl. 709/249

(57) ABSTRACT

A method of restricting data communication to a network, the network comprising a plurality of data processors and a network communication element arranged to receive data communications originating outside the network, the method comprising monitoring data communications originating from outside the network and received at the network communication element and identifying the intended recipient data processor within the network of the received data communications; and determining if the identified intended recipient data processor has a corresponding entry on a record of network data processors and if not, adding a corresponding entry to the first record of network data processors and adding a corresponding entry to a second record of network data processors.

### TECHNICAL FIELD

The present invention relates to restricting the access and propagation of viruses through a network of interconnected data processors.

### CLAIM TO PRIORITY

This application claims priority to copending United Kingdom utility application entitled, “RESTRICTING VIRUS ACCESS TO A NETWORK,” having serial no. GB 0414060.4, filed Jun. 23, 2004, which is entirely incorporated herein by reference.

### SUMMARY

In current network environments virtually any data processor is at one time or another connected to one or more other data processors. Thus, for example, in the case of an IT environment, a data processor in the form of a computer, such as a client, a server, a router, or even a printer, is frequently connected to one or more other computers, whether within an intranet of a commercial organisation, sometimes referred to as a subnet, or as part of the Internet. An inevitable result of the data processor being connected to other such data processors is that the opportunities for the propagation of malicious software such as viruses or worms arise and are enhanced.

Within the context of this specification a virus is data that is accessible by a data processor and that may cause a negative effect upon the performance of the data processor. A characteristic effect of a virus is that it propagates either through self-propagation or through human interaction. Thus, for example, a virus may act by becoming assimilated within a first data processor, and subsequent to its assimilation may then cause harmful effects within that first data processor, such as corruption and/or deletion of data files. In addition, the virus may cause self-propagation to one or more further data processors that will then cause similar corruption/deletion and further self-propagation. In a further alternative scenario, a virus may, for example, become assimilated within a first data processor and then cause itself to be propagated to multiple other data processors within a network. The virus may have no harmful effect upon any of the data processors by whom it is assimilated, however, the self-propagation through the network itself may be of a sufficient magnitude to have a negative effect on the speed of “genuine” network traffic, so that the performance of the network is nonetheless affected in a harmful manner. It will be appreciated that the examples given above are intended for illustration of the typical characteristics of viruses and are not intended to be regarded in any way as exclusively definitive.

From a commercial user's point of view, such virus activity on an intranet or subnet is at best a gross inconvenience due to the amount of time and effort required to prevent access by the virus or to correct the damage caused, and, at worst, is highly damaging as a result of stolen or corrupted data. Consequently, apparatus and methods to prevent intrusion by viruses to computer networks have been developed.

One existing and relatively popular approach to tackling the problems of propagation within a network is to use anti-virus software to monitor the memory, such as the hard disk, and running programs on a computer network traffic, i.e., the communications between interconnected processors, and to look for known patterns or characteristic of viruses. If a virus is discovered within a data processor, that data processor is typically removed from the network immediately and disinfected once the nature of the virus has been established. However, such anti-virus software systems rely on being able to detect known patterns and are therefore by their very nature incapable of detecting a genuinely new virus.

An alternative approach is to learn the “normal behaviour” of the computer system and to detect any anomalies in that behaviour. However, since this approach requires a preferably ongoing period of learning, it is prone to making mistakes. These mistakes fall into two general categories; missing real intrusions (false negatives) and false alarms (false positives). False alarms are problematic because the main response used by such systems is typically to alert an operator to the suspicious activity, and thus corresponds to a waste of the operator's time. If too many false alarms are generated the amount of operator time required to deal with them effectively makes the system unusable. As it is human nature to wish to avoid having to deal with a large number of false alarms the consequence is that the sensitivity of such systems typically tends to be set too low.

A further, more recent, approach is that expounded in the current applicant's co-pending UK patent application GB2391419, incorporated herein by reference. This co-pending application describes the method of restricting the propagation of a virus within a network or subnet by preventing the dispatch of data or other communication packet from a given data processor to other data processors within the network whose identities are not retained within a record of data processors recently contacted by the first data processor in question. The data whose dispatch is prevented is placed in a queue, or buffer, that allows only a certain number of data items to be dispatched in any given period of time. However, this method of restricting the propagation of a virus within a network is only arranged to operate on individual data processors within the network. Therefore, it can, at best, only prevent the further propagation of a virus within a network once an individual data processor has been infected. It is unable to prevent the ingress of the virus to that individual data processor within the network in the first instance.

According to the first embodiment, there is provided a method of restricting data communication to a network, the network comprising a plurality of data processors and a network communication element arranged to receive data communications originating outside the network, the method comprising monitoring the data communications originating from outside the network and received at the network communication element and identifying the intended recipient data processor within the network of the received data communications; and determining if the identified intended recipient data processor has a corresponding entry on a first record of network data processors and, if not, adding the corresponding entry to the first record and adding a corresponding entry to a second record.

Preferably, the intended recipient data processor is identified from the destination network address of the received data communications. The intended recipient data processor may further be identified from the destination port number of the received data communications. If it is determined that the intended recipient data processor does not have a corresponding entry on the first record of network data processors, a corresponding entry is preferably added to the first record. The entry on the first record for a network data processor may include the time of receipt of a previous data communication to the data processor. Consequently, an entry on the first record for a network data processor may be removed from the record if no data communications to that data processor have been received within a given time period. Additionally, an alarm action may be taken in response to the number of entries in the second record exceeding a given number. The alarm action may comprise issuing a notification to a user and/or prevent the further transmission of data communications to the network subsequently received at the network communication element. In addition or alternatively, the alarm action may be taken in response to the number of entries in the second record having a common destination port number exceeding a given number, in which case the alarm action comprises preventing the further transmission of data communications to the network subsequently received at the network communication element having the common destination port.

An alarm action may be additionally or alternatively taken in response to the number of entries in the second record having a common destination network address exceeding a given number. The alarm action may then comprise preventing the further transmission of data communications subsequently received at the network communication element having the common destination network address. A data communication received at the network communication element having a destination port number not having a corresponding entry on a record of port numbers may thus be transmitted to the intended recipient data processor without being delayed.

In some embodiments, the identity of a data processor within the network transmitting a data communication to the network communication element is added to the first record of data processors.

According to a second embodiment, there is provided a communications monitor device arranged to be connected to a network comprising a plurality of data processors and arranged to receive data communications originating from outside the network, the communications monitor being arranged to identify an intended recipient data processor within the network of a received data communication and to determine if the identified intended recipient data processor has a corresponding entry in a first record of network data processors and if not to add a corresponding entry to the first record and add a corresponding entry to a second record.

Additionally or alternatively, the entry for a data processor on the first record of network data processors may include the time of receipt at the network communications device of a previous data communication to that data processor and the communications monitor may be arranged to remove an entry from the first record if the time elapsed since the time of receipt of the previous data communication exceeds a predetermined value.

The communications monitor may also be arranged to monitor the number of entries in the second record and to cause an alarm action to be taken in response to the number of entries exceeding a given value.

The communications monitor is preferably arranged to monitor the number of entries in the second record having a common intended recipient data processor and to cause an alarm action to be taken in response to that number exceeding a given value, the alarm action optionally comprising preventing the further transmission of received data communications to the common recipient data processor.

The communications monitor may additionally or alternatively be arranged to monitor the number of entries in the second record having a common destination port number and to cause an alarm action to be taken in response to that number exceeding a given value. The alarm action may comprise preventing the further transmission of received data communications having the common destination port number. The alarm action may comprise preventing the further transmission of received data communications to the network.

In further embodiments, the communications monitor may be arranged to identify the destination port number of received data communications and to determine if the destination port number has a corresponding entry on a stored list of port numbers and in response to no corresponding entry being found, to transmit the data communication to the intended recipient data processor without imposing a delay.

The communications monitor may be arranged to add an entry to the first record of network data processors in response to a data communication originating from a data processor in the network and being directed to an entity outside the network being received by the network communications device.

The communications monitor preferably comprises a network router.

### BRIEF DESCRIPTION OF THE DRAWINGS

Embodiments of the present invention will now be described, by way of illustrative example only, with reference to the accompanying figures, of which:

FIG. 1 schematically illustrates a network configuration according to the prior art;

FIG. 2 schematically illustrates the configuration of a prior art data processor;

FIG. 3 schematically illustrates a network protocol hierarchy;

FIG. 4 schematically illustrates client/server connections in a network;

FIG. 5 schematically illustrates a network configuration according to an embodiment of the present invention;

FIG. 6 diagrammatically illustrates a communications process according to an embodiment of the present invention;

FIG. 7 diagrammatically illustrates the content of a working set referred to in FIG. 6;

FIG. 8A schematically illustrates the contents of the working set and queue of an embodiment of the present invention in a first behavioural context;

FIG. 8B schematically illustrates the contents of the working set and queue shown in FIG. 8A in a second behavioural context;

FIG. 9 diagrammatically illustrates a communication process according to a further embodiment of the present invention; and

FIG. 10 schematically illustrates the configuration of a throttle in accordance with an embodiment of the present invention.

### DETAILED DESCRIPTION

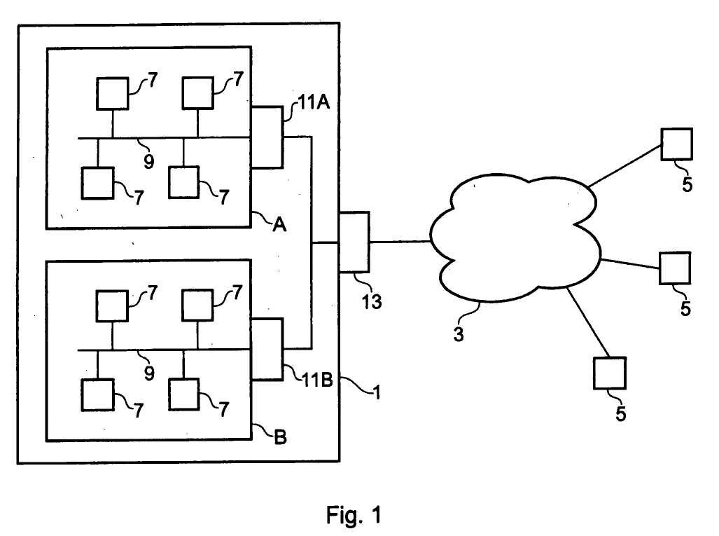

Referring to FIG. 1, a typical form of a network includes an intranet 1, such as a company intranet, connected to an external network 3, such as the Internet. Connected to the external network 3 are a plurality of individual computing entities 5, that may, for example, be individual desktop computers. The intranet may include a number of discrete subnets, of which two, labelled A and B, are shown in FIG. 1. However, it will be appreciated that any number of subnets, from one upwards, may be included within the intranet 1. Each subnet includes a plurality of data processors 7, each of which is connected, in the arrangement shown in FIG. 1, to one another by means of a network backbone 9, which is also connected to a respective router 11a and 11b for each subnet. The router for each subnet is in turn connected to a further router 13 that serves the entire intranet 1 and is the single point of connection for the intranet 1 to the outside network 3. Although each computing entity 7 within the individual subnets A and B are shown as being connected to a network backbone 9, it will be appreciated that other connection arrangements can equally be applied. The function of the routers 11a, 11b and 13 is to manage communications between individual computing entities 7 within the individual subnets A, B and the outside network 3. To achieve better understanding of the embodiments of the present invention, it is helpful to have an appreciation of the communication processes that take place within the intranet 1 and between the intranet 1 and the outside network 3.

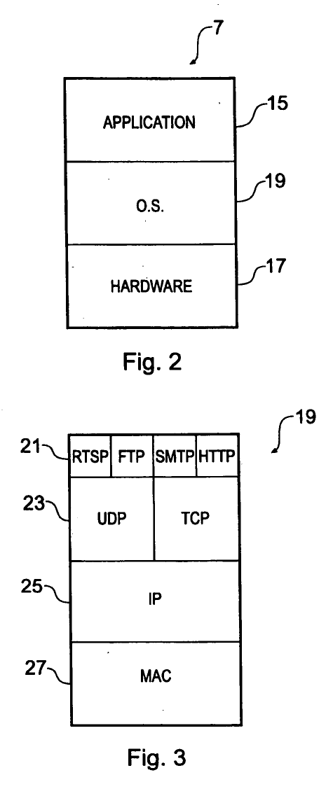

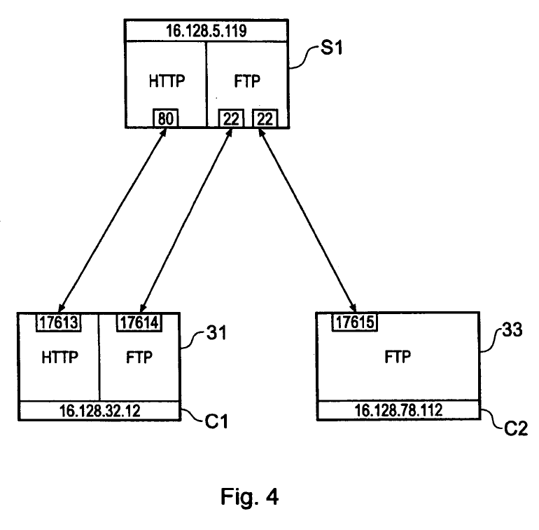

Referring now to FIG. 2, each of the computing entities 7 can be considered to include three functional parts: one or more application programs 15, which in general terms may be thought of as enabling implementation of a particular task that a user of the entity may wish to perform, such as browsing the Internet, word processing and so on; hardware 17, such as one or more hard disk drives, memory, one or more processors, data communication devices, which in the case of the data processors within the intranet 1 shown in FIG. 1 is likely to be a network card; and an operating system 19. The operating system 19 may be thought of, in part, as an interface between the applications program and the hardware, performing scheduling of tasks required by applications programs and allocating memory and storage space, amongst other things. To facilitate communication between the applications 15 and the hardware 17, including communication between separate computing entities, the operating system includes a hierarchy, or stack, of programs that provide the data processor in question with the ability to dispatch and receive data to and from other data processors in the network, in accordance with a number of different sets of formal rules covering the transmission of data across a network, known as protocols. An example of a typical protocol stack is illustrated in FIG. 3. In the present example, four high level protocols 21 are utilised; RTSP (real time streaming protocol, used for the real time streaming of audio and video files), FTP (file transfer protocol, used for the transfer of data files), SMTP (simple mail transfer protocol, for email), and HTTP (hyper text transfer protocol, used for the transfer of web pages). These high level protocols are typically implemented by the application programs themselves. A subsequent layer of protocols 23 includes UDP (user datagram protocol for use with RTSP and FTP) and TCP (transfer control protocol). Below UDP and TCP is a further level protocol 25 IP (Internet protocol). Finally, the network stack includes a bottom level protocol 27, which in this example is MAC (media access control).

When any two data processors within one of the subnets or network are in communication the connection would generally be one of two kinds. The connection may be “connection-based”, which is characterised by a relatively long lasting link being established and the protocols used ensuring that all of the desired data is transferred over the connection, for example, by using “handshake” protocols. This type of connection is used particularly for the transfer of web pages (HTTP) and email (SMTP). The second kind of connection is sometimes termed “connectionless” and is characterised by data being sent from a first data processor to a second data processor without any checks taking place to determine if the transfer has been successful or not. This type of connection is typically used for streaming audio or video where the error checking processes typically used in audio or video data transmission are able to recover or tolerate missing sections of data. In both types of connection, one of the data processors is termed a “client” and the other data processor is termed a “server”. The data processor that provides the desired data will be the server, with the other data processor that requested the data and receives it being the client. It will be appreciated that any individual data processor providing desired information is operating as a server and the term is not limited to large data processors storing a large amount of data to be provided to a number of individual clients, such as a “web server”.

For a connection between individual data processors to be successfully established and communication performed, it is necessary for each data processor to have a unique identifying address on the network. In a network utilising the IP protocol, this is achieved by allocating an IP address to each machine on the network. Although each machine on the network has a unique IP address, the address is typically reallocated each time the machine is connected to the network, for example, whenever a desktop computer is switched on and connection to the network established. Consequently, the IP address for the same data processor may change over time. The IP address comprises a binary number four bytes in length and is usually written using “dotted-decimal” notation. For example, an IP address of a data processor may be written as 23.192.5.12. Part of the function of the IP protocol is to add the IP address of the destination data processor to packets of data that are to be set to that data processor, the data having been formed into packets by the higher level protocols, such as UDP or TCP.

As an aside, when the network includes intranets and further subnets a subnet mask is used in conjunction with the IP addresses. Like IP addresses, a subnet mask contains four bytes and is typically written using the same “dotted-decimal” rotation. The subnet mask is used to identify the subnet, or intranet, to which an IP address belongs by performing a bitwise AND operation between the subnet mask and the IP address. The result is the subnet work address. For example, address 192.1.2.22 with subnet mask 255.255.0.0 becomes 192.1.0.0. For network purposes, further host 192.1.5.12 is on the same network, based on the mask specified, as the work address is also 192.1.0.0. In this case, a router would not need to be accessed for the communication. A host at 192.8.12.34 would be considered as part of a different network, however, since the subnet work address comes out to be 192.8.0.0, which does not match the previous two subnet addresses. In this second case, the communication would have to be directed through the subnet, or intranet, router.

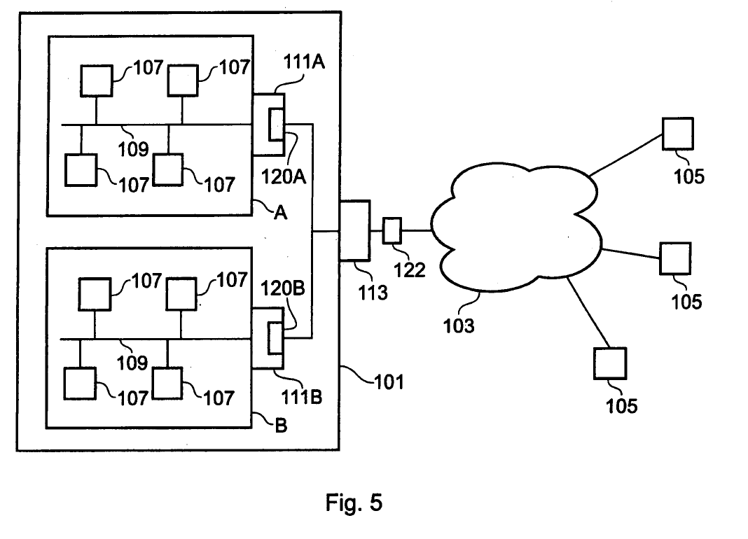

As mentioned previously, separate applications running on the same data processor may make use of different protocols to establish individual connections, with the result that a data processor may well be involved in a number of connections simultaneously. For example, an individual accessing the Internet may well establish a HTTP connection so as to view pages from the worldwide web, whilst simultaneously establishing an RSTP connection to allow the streaming of audio or video data to his or her individual data processor. To facilitate multiple connections between the two data processors the concept of “ports” is used. In this context a port is the end point of a logical communication channel, as opposed to a point of connection between items of hardware. A single data processor connected to a network via a single network cable or telephone line can be communicating over the network using a multiplicity of ports open. As there is a port at either end of the logical communication channel, on either communicating data processor, it is convenient to refer to destination and source ports to signify the direction of the communication flow. Each port is identified by a port number and certain numbers are reserved for use with particular applications, or connection types. For example, port 80 is reserved for connections with web server applications. A web server application in a data processor will monitor port 80 for connection attempts being made to that web server. Similarly, port 22 is reserved for FTP (file transfer protocol) connection attempts. Other port numbers are allocated arbitrarily when individual connections are established. A simple example of the use of port numbers is illustrated in FIG. 4.

Within a subnet a server S1 is provided, having IP address 16.128.5.119, that is arranged to operate as both an HTTP and an FTP server. A first client C1, also within the same subnet and having IP address 16.128.32.12, includes a HTTP application 29. To establish a HTTP connection between the first client C1 and the server S1 the client C1 creates a port having port number 17613 and issues a connection request to the server S1. The connection request will specify the IP address and allocated port number of the client C1 as the source address and source port respectively, together with the IP address of the server S1 as the destination address. As an HTTP connection is required, the connection request will further specify port 80 on server S1 as the destination port. On receipt of the connection request at the server, the desired information is returned to the client C1 using the combination of the IP address of the client and the allocated port number, in this case 17613 as the destination address and port. The client C1 also includes an FTP application 31. When an FTP connection is required, the client C1 creates a second port, port number 17614, and directs a connection request to port 22 of the server S1, port 22 being reserved for FTP connections. In this instance, the source IP address is again that of the first client C1, but the source port is the newly created port, port no. 17614. The returning information is sent from the server S1 to the client C1 and specifically to port number 17614. When a server is prepared to receive data on a particular port, that port is termed as being open. It is entirely possible for multiple HTTP or FTP connections to be established between the first client C1 and the server S1, as each individual connection will have an individual port number allocated by the client C1. Individual port numbers on the client C1 therefore enables the server S1 to distinguish between different connections. In a similar manner, a second client C2, also on the network having an IP address of 16.128.78.112, also has an FTP application 33 and establishes a connection with the FTP server on server S1, with the client C2 allocating a port number of 17615. Hence, the FTP application on server S1 has two connections on port 22 but distinguished by differing port numbers and IP addresses. Although, in the examples shown in FIG. 4, the port numbers on the individual clients are all different, it is quite possible that individual clients may allocate the same port number. However, the connection can still be distinguished because of the different IP addresses of the separate clients. Consequently, a connection is fully identifiable by the port number/IP address pair.

As previously mentioned, each data processor on a network has a unique IP address. Typically, however, a user of a data processor will use a text label to refer to a desired connection source. For example, a user running a web browser application will typically enter a known web address, such as www.hpinvent.com, to initiate a connection to the “hpinvent” server. It is a function of one or more Domain Name Servers (DNS) to “resolve” the text label to the correct IP address as expressed in dotted decimal form. In a gross simplication, the resolving process comprises individual domain name servers trying to match the web address against a table of known web addresses, each known web address having a corresponding entry in the table containing the required IP address. However, should the individual user happen to know the IP address of the required server that IP address could equally be directly entered. It is the fact that IP addresses are essentially just numbers that are exploited by many viruses and worms. The virus will generate a large number of IP addresses, either completely at random or making use of some known attribute, such as that a particular subnet has IP addresses beginning with the number 16, and will attempt to initiate a connection to each of the generated IP addresses. Whilst many of the generated IP addresses will not be valid, because of the very large number of IP addresses generated some will match genuine IP addresses of data processors on the network or a subnet. If the data processors with the genuine IP addresses have a port open with the same port number as that generated in the attempted viral connection the virus will be able to establish a genuine connection and infect the target data processor. The likelihood of a data processor having a particular port open is increased by the fact that certain port numbers are reserved for well known applications, as previously mentioned. Therefore, a data processor that happens to be configured as a web server will have port 80 open to receiving coming connection requests on that port number. Therefore, viruses often pair the generated IP addresses with a well known port number. Furthermore, some data processor applications are known or are found to include inadvertent configurations that make the data processor running the application prone to the above mentioned kind of virus attack. For example, the default settings of some computers may include automatically opening port 80, thus appearing as a server.

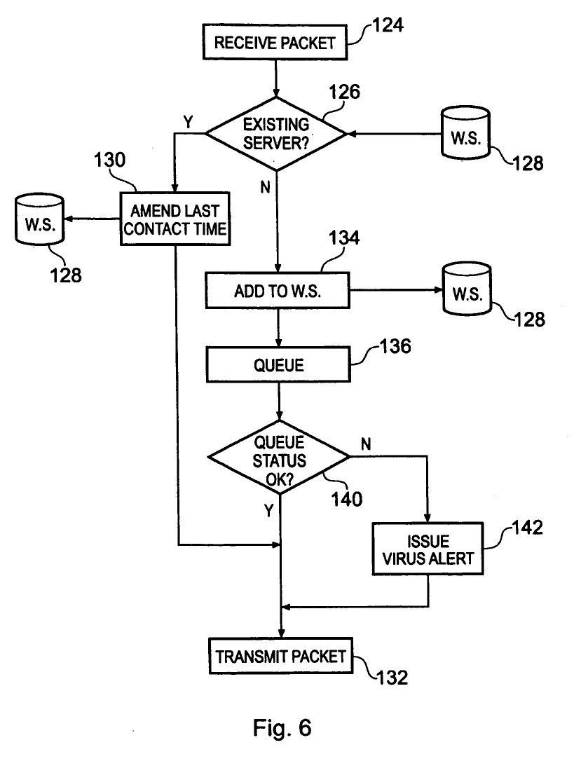

A network arranged according to an embodiment of the present invention is schematically illustrated into FIG. 5. In a similar fashion to that shown in FIG. 1, the network comprises an intranet 101 that in turn comprises, in the example shown, two further subnets A, B. Each subnet includes a plurality of data processors 107 interconnected, for example, by a network backbone 109 to a router 111a, 111b. Each of the routers for the subnets are in turn connected to a router 113 serving the intranet 101. The router 113 for the intranet 101 is connected to an external network 103, such as the Internet, which in turn is connected to one or more further individual data processors 105. Each of the two routers 111a and 111b serving the respective subnets is provided with a throttling arrangement 120a, 120b. A similar throttling arrangement is provided as a separate unit 122 between the router 113 serving the intranet 101 as a whole and the external network 103. Whether the throttle arrangement is provided separately from, or integrated into, the respective routers is not of importance to the function of the present invention and any combination of throttle arrangement can be applied.

Each throttle arrangement 120a, 120b, 122 is arranged to monitor incoming traffic arriving at the respective network or subnet. The traffic is monitored in terms of attempted connections to individual data processors 107 within the respective subnets. Each attempted connection is identified by an IP address/port number pair. Each throttle arrangement maintains a working set for its respective subnet, the working set comprising a list of IP address/port number pairs. Under normal operating conditions, the working set contains the normal valid server destination IP addresses and destination ports for the subnet in question. The number of valid servers is likely to vary only slowly over time for any given subnet, as the number of separate servers is likely to be substantially constant, but may vary greatly from one subnet to another. For example, a subnet comprising mostly of desktop personal computers is likely to have a small number of server destination addresses, whereas a subnet dedicated to web servers will have a large number of server destination addresses. According to the methodology of the embodiment of the present invention, an IP address/port number pair is added to the working set of a subnet whenever a connection request is received at the respective throttle, with IP address/port number pairs being removed from the working set when the particular server identified by a pair has been inactive for a certain period of time. In this fashion, a regularly active server stays in the working set and cannot be removed, and its response time to users adversely affected, simply because there are other servers on the same subnet. Also, new servers are easily added to the working set, whilst old ones are automatically removed.

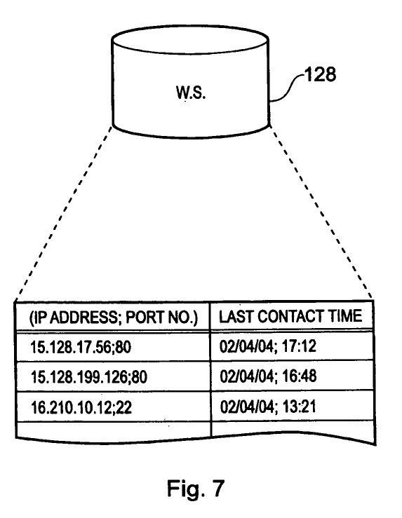

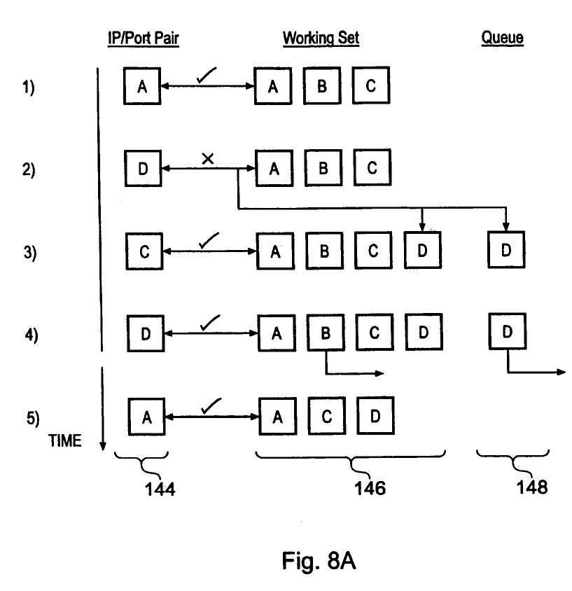

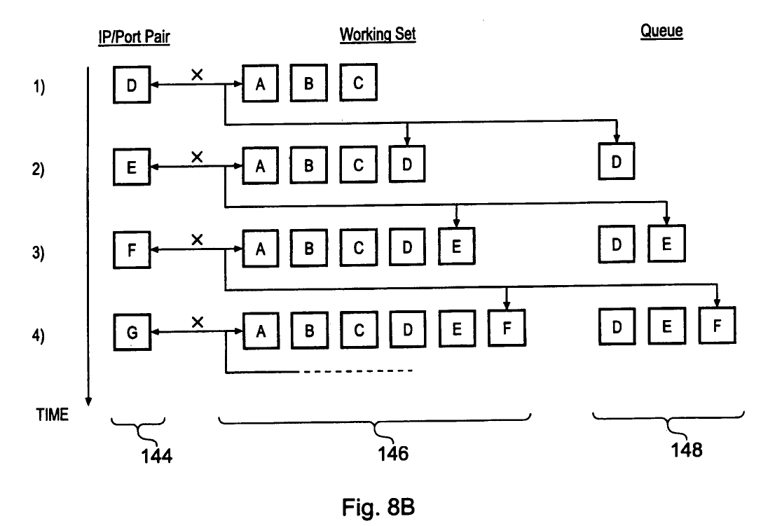

The method of operation of the throttle according to an embodiment of the present invention, is schematically illustrated in FIG. 6. At an initial step 124, the throttle receives a data packet containing a connection request. For networks using the TCP protocol, the connection request will typically comprise a synchronisation request packet, SYN. The packet data includes, as part of the packet headers, both the IP address of the destination data processor and the destination port number on which the connection is to be established. At the next step 126, the throttle checks to see if the destination data processor identified by the received packet is an existing server or not. This is done by checking the destination IP address/port number pair against a stored list of pairs, referred to herein as the working set 128. The working set is shown schematically at FIG. 7 and is represented as a table comprising IP address/port number pairs and, optionally, their associated last contact time identified by the date and time of receipt of the data packet. If the data processor has a matching entry in the working set, the working set 128 is preferably amended by updating the last contact time of the identified server to the current time, as shown at step 130 in FIG. 6, and the received packet is forwarded at step 132 to the identified destination data processor. If at step 126 it is determined that the intended destination data processor does not have a matching entry in the working set, it is added to the working set 128 at step 134, preferably together with the current contact time. A separate entry for the IP address and port number pair is also placed in a queue at step 136. The received data packet is then transmitted to the destination data processor, as indicated at step 132. It should be understood that although the actions of adding an entry to the working set, adding an entry to the queue and transmitting the data packet are shown in FIG. 6 as sequential actions this is for clarity only and each action may be performed independently of each other. After a predetermined period of time, configurable by the user, the first IP address/port number pair are removed from the queue 136. This is explained further with reference to FIG. 8. The status of the queue is also monitored, as shown at step 140 in FIG. 6. One measure of the status of the queue is the number of IP address/port number pair entries held in it. As will be explained in more detail with reference to FIG. 8, a large number of entries in the queue is indicative of an attempted viral infection from outside the network. If this is detected an alert is issued, as shown at step 142 in FIG. 6.

As mentioned above, one measure of the status of the queue in which IP address/port number pairs are held is the number of such entries in the queue at any given time. A representation of how the contents of the queue and the working set vary over time under normal network operating conditions is shown in FIG. 8A. Each row represents a point in time at which a connection request has been received and the IP address/port number pair is being processed. The labelled boxes under the ‘IP/Port Pair’ heading 144 represent each IP/port no. pair, those under the ‘Working Set’ heading 146 the IP/port no. pair entries in the working set and those under the ‘Queue’ heading 148 the contents of the queue 136. At the first occurrence, the IP/port no. pair of the received connection request is labelled A. At this point in time, the working set contains entries for IP address/port no. pairs A, B and C. Consequently a match, represented by the tick, is found between the IP address/port no. pair and an entry in the working set and no modification of the working set or queue takes place. At the next time instant, shown as row 2, a connection request having a destination IP address/port no. pair labelled D has been received. There is no corresponding entry in the working set, shown by the cross, so the IP/port no. pair D is added to both the working set and the queue. It will be appreciated that, as described previously with reference to FIG. 6, the connection request D is nonetheless transmitted to the destination data processor. At the next time instance, row 3, the received IP address/port no. is again different and is labelled C. As there is already a corresponding entry in the working set, no further modification of the working set or queue occurs. It will be noted that the working set and queue now each contain an entry corresponding to the IP/port no. pair D. At the next instance, row 4, a further connection request for the IP address/port no. pair D is received. As the working set now contains an entry for the pair D, a match is found. Also represented at row 4 is the removal of the queue entry for the pair D. This occurs on a time elapsed basis. In addition, the entry for the IP address/port no. pair B is shown as being removed from the working set. This occurs when no matches have been made against an entry within a given time period. Row 5 again illustrates the successful match of the known IP address/port pair A.

FIG. 8B represents the behaviour of the working set and queue in the case of an attempted viral attack. At the first time instance, row 1, no match is made between the contents of the working set and the IP address/port no. pair, labelled D, of the received connection request. Consequently an entry for pair D is added to both the working set and the queue. This pattern is repeated over the next 3 time periods, with unknown destination IP address/port no. pairs E, F and G being processed. This will continue until a predetermined number of entries in the queue is reached, at which point an alarm is triggered. The rate at which entries are removed from the queue, as described with reference to FIG. 8A, is set much lower than the likely rate of receipt of unknown destination IP address/port no. pairs during a virus attack. It will be noted that before the alarm is triggered the received connection request themselves are passed through to the subnet. However, these are not likely to be valid IP address/port no. pair destinations so the chance of a virus reaching an actual data processor before the alarm is triggered is low.

Each entry in the working set 128 is preferably examined at a predetermined interval, for example, by checking if the previous contact time for a given IP address and port number is more than a predetermined time period in the past. If it is, the entry is removed from the working set. In this manner, IP addresses that are not regularly accessed on the specific ports are removed from the working set. However, other criteria may be defined to manage the entries on the working set. For example, an entry can be removed if no connection requests have been accepted by the destination data processor defined in the IP address, port number pair.

When an attempted virus infection is detected and a virus alert issued, one or more actions can be taken. For example, no further connections to destination data processors not already in working set may be permitted, or no new incoming connections may be permitted at all. For protocols such as TCP/IP where the source address of the connection request is also part of the data packet, further actions may be taken. For example, all incoming data packets from the identified source IP address may be prohibited from passing through the router. Similarly, the port number may be used to control further incoming connection requests, for example, by preventing any new connection requests on a particular port number.

As mentioned previously, the network stack 144 may include “streaming” protocols, such as RTSP and FTP. Connections based on such streaming protocols are initiated by a connection request from the client to the server, with the client identifying its IP address and port number on which the connection is to be based, and the server subsequently returning a series of packets to the client, with no further acknowledgements or requests being issued by the client. Every time a particular client establishes an RTSP or FTP connection, the client will typically assign a different port number. Consequently, although the data packets from the RTSP or FTP server specifying the client IP address and port number could be processed by the method of the present invention previously described, with the IP address and port number pair being placed in the working set, as this pair is extremely unlikely to be reused once the streaming connection has been terminated, it would be more efficient not to have to place the IP address and port pair in the working set in the first place.

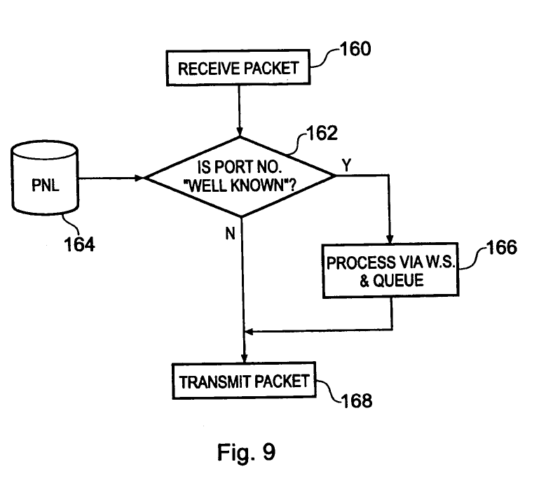

According to further embodiments of the present invention, this is dealt with by applying the method steps schematically illustrated in FIG. 9. An initial data packet 160 is received at the network router. As previously, part of the data packet will include: the intended destination IP address and corresponding port number. At the subsequent step 162, the destination port address is examined to see if it corresponds to a “well known” port number. A list of well known port numbers is typically held in memory 164 accessible by the throttle. As previously mentioned, certain port numbers are reserved for use with particular protocols and/or functions. For example, port number 53 is reserved for connections to a DNS server. If the destination port number corresponds to a “well known” port number, this signifies that the destination data processor in the network identified by the IP address is considered to be a server, for example, a DNS server. Consequently, the received data packet is processed at step 166 in accordance with the previously described method of the present invention. That is to say, that the specified destination IP addresses and port number is processed using the working set and queue. However, if the destination port number does not correspond to a “well known” port then it can reasonably be assumed that the data packet has been sent to the specified destination data processor in response to a previous connection request sent from that data processor, in which the identified port number was specified by the data processor as the source port, the destination data processor acting as a client, not a server. As the data packet is therefore assumed to have been sent in response to an earlier request, it is transmitted directly to the specified destination data processor, represented at step 168 in FIG. 9, without making use of the working set or queue.

In a further alternative, it is assumed that the source IP address and port number pairs associated with data packets transmitted from a data processor within the network or subnet are likely to be either current destinations of incoming data packets or future destinations of data packets yet to be received. The throttle is therefore arranged to monitor this outgoing traffic and to check the source address/port number pairs against the contents of the working set. If a source IP address and port number pair are not contained within the working set, they are added and the data packet held in the queue as previously described. This means that a subsequent incoming data packet with the destination IP address and port number corresponding to the previously monitored outgoing packet will be recognised as a valid transmission, due to the match found in the working set, and transmitted to the specified data processor without delay. For example, a data processor within the network makes a connection request to a known FTP server, specifying its own allocated port number for return transmissions. The IP address and assigned port number of the data processor within the network is added to the working set by the throttle such that data packets sent in return to the data processor by the FTP server that specify the data processors IP address and allocated port number are not delayed.

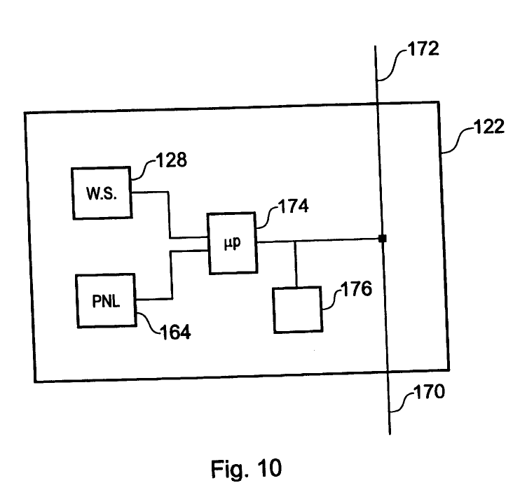

An implementation of the throttle arrangement of embodiments of the present invention is schematically illustrated in FIG. 10. The throttle unit 122 is in communication with the external network 103 and the internal network 101 (both not shown) by means of respective communications links 170 and 172. A data processor 174 is also in communication with the communications links and is configured to monitor the communications received from the external network. In some embodiments, the data processor 174 is also configured to monitor the communications received from the internal network. The data processor is also coupled to a delay buffer 176 in which received communications may be held under the control of the data processor. The data processor 174 is additionally coupled to storage devices in which the working set 128 and port number list 164 are stored. The data processor is configured to access the working set and port number list and to amend the entries therein in accordance with the method of embodiments of the present invention discussed previously. It will be appreciated that the delay buffer 176, working set 128 and port number list 164 may be implemented as integrated memory, such as RAM, or as discrete memory devices such as hard disks. It will also be appreciated that they may be implemented on a single physical memory medium, with a logical divisional being applied by the data processor 174. In embodiments in which the throttle unit 122 is integrated with a respective router 102, 113 the functions of the data processor may be performed by an existing data processor of the router, with any data storage resident on the router being used for storage of one or more of the working set, port number list and delay buffer.

1. A method of restricting data communication to a network, the network comprising a plurality of data processors and a network communication element arranged to receive data communications originating outside the network, the method comprising:
monitoring the data communications originating from outside the network and received at the network communication element and identifying the intended recipient data processor within the network of the received data communications; and
determining if the identified intended recipient data processor has a corresponding entry on a record of network data processors and if not, adding the corresponding entry to a first record of network data processors, and adding the corresponding entry to a second record of network data processors.

2. The method of claim 1, wherein the intended recipient data processor is identified from a destination network address of the received data communications.

3. The method of claim 2, wherein the intended recipient data processor is further identified from a destination port number of the received data communications.

4. The method of claim 1, wherein an entry on the first record for the network data processor includes a time of receipt of a previous data communication to the data processor.

5. The method of claim 4, wherein the entry on the first record for a network data processor is removed from the first record if no data communications to that data processor have been received within a given time period.

6. The method of claim 1, wherein an alarm action is taken in response to the number of entries in the second record of data processors exceeding a given number.

7. The method of claim 6, wherein the alarm action comprises issuing a notification to a user.

8. The method of claim 6, wherein the alarm action comprises preventing the further transmission of the data communications to the network subsequently received at the network communication element.

9. The method of claim 1, wherein the alarm action is taken in response to the number of entries in the second record of data processors having a common destination port number exceeding the given number.

10. The method of claim 9, wherein the alarm action comprises preventing the further transmission of data communications to the network subsequently received at the network communication element having the common destination port.

11. The method of claim 1, wherein the alarm action is taken in response to the number of entries in the second record of data processors having a common destination network address exceeding the given number.

12. The method of claim 11, wherein the alarm action comprises preventing the further transmission of data communications subsequently received at the network communication element having the common destination network address.

13. The method of claim 3, wherein the data communication received at the network communication element having the destination port number not having the corresponding entry in a third record of port numbers is transmitted to the intended recipient data processor without being delayed.

14. The method of claim 1, wherein the identity of the data processor within the network transmitting the data communication to the network communication element is added to the first record of data processors.

15. A communications monitor arranged to be connected to a network comprising a plurality of data processors and arranged to receive data communications originating from outside the network, the communications monitor being arranged to identify an intended recipient data processor within the network of a received data communication and to determine if the identified intended recipient data processor has a corresponding entry in a first record of network data processors and if not to add the corresponding entry to the first record of network data processors and to add the corresponding entry to a second record of network data processors.

16. The communications monitor of claim 15, wherein the entry for the data processor on the first record of network data processors includes a time of receipt at a network communications device of a previous data communication to that data processor and the communications monitor is arranged to remove the entry from the first record if the time elapsed since a time of receipt of a previous data communication exceeds a predetermined value.

17. The communications monitor of claim 15, wherein the communications monitor is arranged to monitor the number of entries in the second record of network data processors and to cause an alarm action to be taken in response to the number of entries exceeding a given value.

18. The communications monitor of claim 17, wherein the alarm action comprises preventing the further transmission of received data communications to the network.

19. The communications monitor of claim 15, wherein the communications monitor is arranged to monitor the number of entries in the second record of network data processors having a common intended recipient data processor and to cause the alarm action to be taken in response to that number exceeding the given value.

20. The communications monitor of claim 19, wherein the alarm action comprises preventing the further transmission of received data communications to the common intended recipient data processor.

21. The communications monitor of claim 15, wherein the communications monitor is arranged to monitor the number of entries in the second record of network data processors having a common destination port number and to cause the alarm action to be taken in response to that number exceeding the given value.

22. The communications monitor of claim 21, wherein the alarm action comprises preventing the further transmission of received data communications having the common destination port number.

23. The communications monitor of claim 21, wherein the communications monitor is arranged to identify the common destination port number of the received data communications and to determine if the common destination port number has the corresponding entry on a further stored list of port numbers and in response to no corresponding entry being found, to transmit the data communication to the common intended recipient data processor without imposing a delay.

24. The communications monitor of claim 15, wherein the communications monitor is arranged to add an entry to the first record of network data processors in response to a data communication originating from a data processor in the network and being directed to an entity outside a network being received by a network communications device.

25. A communications monitor of claim 15, further comprising a network router.

26. A network comprising:
a plurality of data processors;
a network communications device; and
a communications monitor arranged to be connected to the network, arranged to receive data communications originating from outside the network, and further arranged to identify an intended recipient data processor of a received data communication, so that the communications monitor determines if the identified intended recipient data processor has a corresponding entry in a first record of network data processors, and if not, adds a corresponding entry to the first record of network data processors and adds a corresponding entry to a second record of network data processors.
